(19) United States
(12) Patent Application Publication
(10) Pub. No.: US 2005/0238031 A1
(43) Pub. Date: Oct. 27, 2005

(54) Method and system for supporting simultaneous data sessions of dissimilar access networks

(75) Inventors: Kunnath Sudhir, Bolingbrook, IL (US); Arun C. Alex, Bartlett, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 10/829,521

(22) Filed: Apr. 22, 2004

(51) Int. Cl. H04L 12/56; H04L 12/28

(52) U.S. Cl. 370/401; 370/466

(57) ABSTRACT

A method and system for supporting, at a PDSN, simultaneous data sessions on dissimilar access networks. A PDSN has a first network communication interface for connection to a first network, a second network communication interface for connection to a second network, and a protocol abstraction routine executable by a processing unit. The PDSN can use the protocol abstraction routine to identify if a data packet is associated with a first RP transfer protocol or a second RP transfer protocol. After making the determination, the protocol abstraction routine can decapsulate or encapsulate the data packet according to the associated RP transfer protocol, for transmission to the first network or the second network.

### BACKGROUND

1. Field of the Invention

A system and method for providing support at a packet gateway to simultaneous data sessions using different RP transfer protocols.

2. Description of Related Art

Wireless data communications is becoming an increasingly popular means of personal communication and information access in the modern world. Currently, people are using wireless data networks for exchanging information in the form of e-mail and data (i.e., web pages), as well as other forms, using wireless telephones, personal digital assistants (“PDAs”), and other devices. In principle, a user can access the Internet, for instance, from anywhere inside the coverage area of a wireless data network.

In order to meet the rising demand for access to wireless data networks, network providers often need to upgrade their existing wireless infrastructure to accommodate data access. Due to the high investment costs of wireless communication infrastructure, interoperability of infrastructure devices is highly desirable. One area where this is of particular importance is for packet data serving node (“PDSN”) packet gateways. Currently, there are multiple packet control function (“PCF”)-PDSN transfer control protocols (“RP Protocols”) used for transferring data between a PCF of a base station controller (“BSC”) and a PDSN (i.e., open-RP and closed-RP protocols). Currently, a single PDSN is not capable of simultaneously supporting data sessions using more than one RP protocol. As a result, wireless data service providers must purchase, install, and maintain at least two separate PDSNs to support simultaneous data sessions using both RP protocols, resulting in increased network complexity, increased investment costs, and increased maintenance costs.

As a result, the ability of a single PDSN to simultaneously support multiple data sessions using at least two different RP protocols would be desirable to wireless data service providers, and especially to wireless data service providers having existing network infrastructure, some supporting open-RP and some supporting closed-RP. Currently, for instance, if a wireless data provider's infrastructure includes a first BSC with a PCF that establishes data sessions via a PDSN using the open-RP protocol, and a second BSC with a PCF that establishes data sessions via a PDSN using the closed-RP protocol, in order for the network to simultaneously support data sessions on the first and second BSCs, the network must employ two separate PDSNs—one for data sessions using the open-RP protocol and one for data sessions using the closed-RP protocol. Therefore, there is a need for a PDSN that can support at least two simultaneous data sessions using different RP protocols.

### SUMMARY

A method and system for supporting, at a PDSN, simultaneous data sessions on dissimilar access networks is provided. According to an exemplary embodiment, a PDSN is provided that has a first network communication interface for connection to a first network, a second network communication interface for connection to a second network, and a protocol abstraction routine executable by a processing unit. The protocol abstraction routine can be used to identify if a data packet is associated with a first RP transfer protocol or a second RP transfer protocol. Additionally, the protocol abstraction routine can decapsulate or encapsulate the data packet according to the associated RP transfer protocol for transmission to one of the first network and the second network.

According to another exemplary embodiment, a method for supporting simultaneous data sessions on dissimilar access networks is provided. The method comprises receiving a data packet from a first network and identifying if the data packet corresponds to a first RP transfer protocol or a second RP transfer protocol. Next, the data packet is encapsulated or decapsulated according to the first RP transfer protocol when the data packet is associated with that RP transfer protocol. Alternatively, the data packet is encapsulated or decapsulated according to the second RP transfer protocol when the data packet is associated with that RP transfer protocol.

These and other aspects and advantages will become apparent to those of ordinary skill in the art by reading the following detailed description, with reference where appropriate to the accompanying drawings. Further, it should be understood that the foregoing summary is merely exemplary and is not intended to limit the scope of the invention as claimed.

### BRIEF DESCRIPTION OF THE DRAWINGS

An exemplary embodiment is described herein with reference to the drawings, in which:

FIG. 1 is a block diagram illustrating components of an exemplary cellular radio communications system coupled to a packet network via a PDSN;

FIG. 2 is a block diagram illustrating a PDSN that may be used in accordance with the exemplary embodiment;

FIG. 3 is a block diagram illustrating components of an exemplary cellular radio communications system coupled to a packet network via a PDSN that may be used in accordance with the exemplary embodiment;

FIG. 4 is a block diagram illustrating components of an exemplary cellular radio communications system coupled to a packet network via a PDSN that may be used in accordance with the exemplary embodiment;

FIG. 5 is a flowchart illustrating a functional process flow in accordance with the exemplary embodiment; and

FIG. 6 is a flowchart illustrating a functional process flow in accordance with the exemplary embodiment.

### DETAILED DESCRIPTION OF AN EXEMPLARY EMBODIMENT

1. Exemplary Architecture

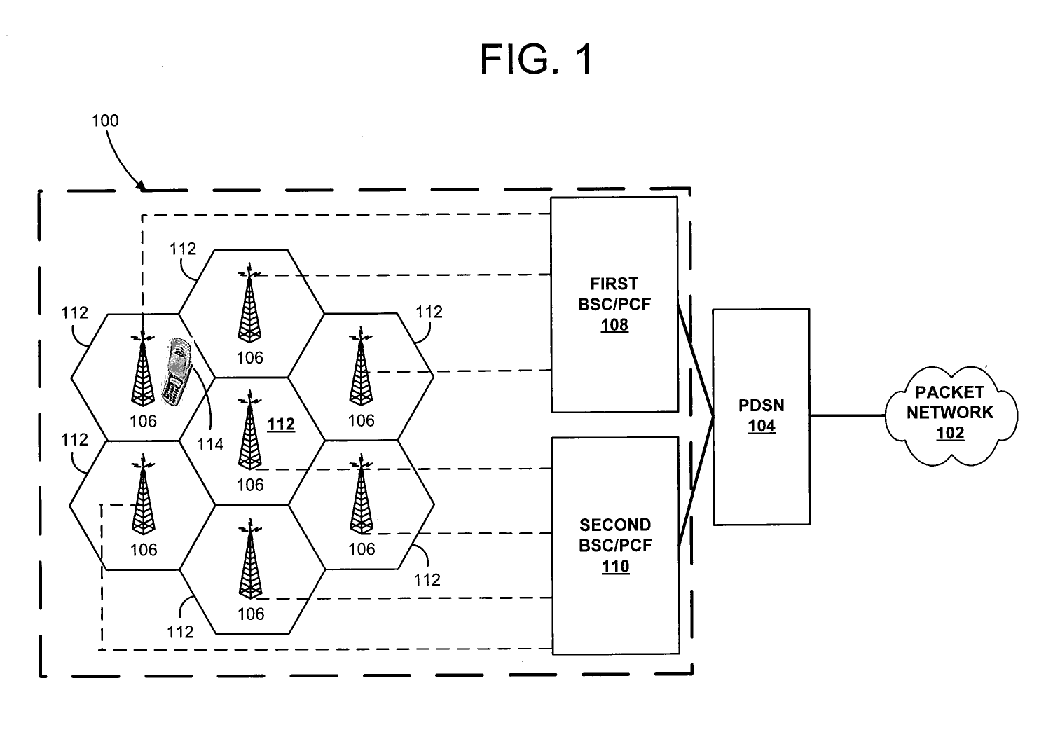

Referring to the drawings, FIG. 1 is a block diagram illustrating components of a cellular radio access network 100, connected to a packet network 102 via a typical PDSN 104. A radio access network 100 is typically comprised of at least a base transceiver station (“BTS”) 106 antenna and a BSC 108, 110.

In a typical radio access network 100, an area is divided geographically into a number of cell sites 112. Each cell 112 can be defined by a radio frequency (“RF”) radiation pattern from a respective BTS 106 antenna, and each cell 112 can include one or more sectors (not shown for clarity). Each BTS 106 can typically transmit and receive wireless communications to and from a plurality of mobile stations 114, illustrated in FIG. 1 as a cellular telephone, located within its coverage area.

As depicted in FIG. 1, a mobile station 114 is located within a cell 112 of the radio access network 100. The mobile station 114 may be any type of wireless device, such as a mobile phone, a personal digital assistant (“PDA”), a two-way pager, a two-way radio, a wirelessly equipped computer or another wireless device. While FIG. 1 depicts one mobile station 114 within the cell 112, a cell 112 may include greater or fewer numbers of mobile stations 114, and it is not necessary that the mobile stations 114 all be the same type of wireless device.

Each BTS 106 might connect to a BSC 108, 110. As its name suggests, the BSC 108, 110 can function to control communications via one or more BTSs 106. For instance, in some arrangements, a BSC 108, 110 might control the power level of wireless signals emitted by a BTS 106, and might control the handoff of communications as a mobile station 114 moves between cells 112 within a BTS 106 coverage area.

Each BSC 108, 110 might then be coupled to a telecommunications switch or gateway, such as a mobile switching center (not shown in FIG. 1) and/or a PDSN 104, for instance. The PDSN 104 might be coupled to one or more BSCs 108, 110, as well as one or more packet networks 102, and might manage packet data sessions established by the mobile stations 114 over the radio access network 100. The packet network 102 might be the Internet, for instance.

A mobile station 114 might communicate with the BTS 106 via an air interface using a variety of different protocols. In one exemplary embodiment, the mobile station 114 can communicate with the BTS 106 using Code Division Multiple Access (“CDMA”), such as in a CDMA2000 3G-packet network. CDMA provides a method for sending wireless signals between the mobile station 114 and the BTS 106. In a CDMA system, the mobile stations 114 communicate with the BTS 106 over a spread spectrum of frequencies.

CDMA is described in further detail in Telecommunications Industry Association (“TIA”) standards IS-95A and IS-95B, which are both incorporated herein by reference in their entirety. CDMA is also described in the International Telecommunications Union (“ITU”) IMT-2000 series of standards, which are all incorporated herein by reference in their entirety. CDMA is further described in the TIA IS-2000 series of standards, which are all incorporated herein by reference in their entirety. The IS-2000 series of standards are commonly referred to as CDMA2000.

Other protocols may also be used for communication between the mobile station 114 and the BTS 106. For example, the mobile station 114 and the BTS 106 might communicate using Wideband CDMA (“WCDMA”), Time Division-Synchronous CDMA (“TD-SCDMA”), Advanced Mobile Phone Service (“AMPS”), Digital AMPS (“D-AMPS”), Universal Mobile Telecommunications System (“UMTS”), Global System for Mobile Communication (“GSM”), General Packet Radio Services (“GPRS”), IS-136, Time Division Multiple Access (“TDMA”), Frequency Division Multiple Access (“FDMA”) or other protocols. Additional wireless protocols, such as Institute of Electrical and Electronics Engineers (“IEEE”) 802.11, Bluetooth, and others may also be used.

The PDSN 104 shown in FIG. 1 can be used as a gateway to transfer data packets between a radio access network 100 and a packet network 102, such as the Internet, an intranet, or another packet network. A mobile station 114 can use this connectivity provided by the radio access network 100 and the PDSN 104 to communicate with devices on the packet network 102. A PDSN 104 typically communicates with a radio access network 100 via a packet control function (“PCF”). PCFs are typically incorporated into BSCs 108, 110, but separate, stand-alone devices are possible as well. For the BSC 108, 110 to communicate with the PDSN 104 via the PCF, a PCF-PDSN transfer protocol, known as an RP protocol, is used. Each PDSN 104 may be in communication with a plurality of BSCs 108, 110 at any time, however, all of the BSCs 108, 110 must use the same RP protocol. Currently, the two main RP protocols are open-RP and closed-RP. Open-RP is described in further detail in Telecommunications Industry Association (“TIA”) standards IS-835C which is incorporated herein by reference in its entirety. Closed-RP is a proprietary standard developed and maintained by Nortel Networks Corporation of Ontario, Canada.

When connecting to the radio access network 100 for data services, the mobile station 114 might establish a Point-to-Point Protocol (“PPP”) session with the PDSN 104. As is known in the art, PPP is a data link protocol for communication between two devices. Once connected to the PDSN 104, for example through a PPP session, a mobile station 114 can access the Internet or another packet network 102. While the mobile station 114 may communicate with the PDSN 104 through a PPP session, it may communicate with other devices using higher-level protocols. For example, the mobile station 114 may additionally use the Transmission Control Protocol (“TCP”), the User Datagram Protocol (“UDP”) or other protocols.

PPP is described in more detail in Internet Engineering Task Force (“IETF”) Request for Comments (“RFCs”) 1661, 1662, and 1663, all of which are incorporated herein by reference in their entirety. TCP is described in more detail in IETF RFC 793, which is incorporated herein by reference in its entirety. UDP is described in further detail in IETF RFC 768, which is incorporated herein by reference in its entirety.

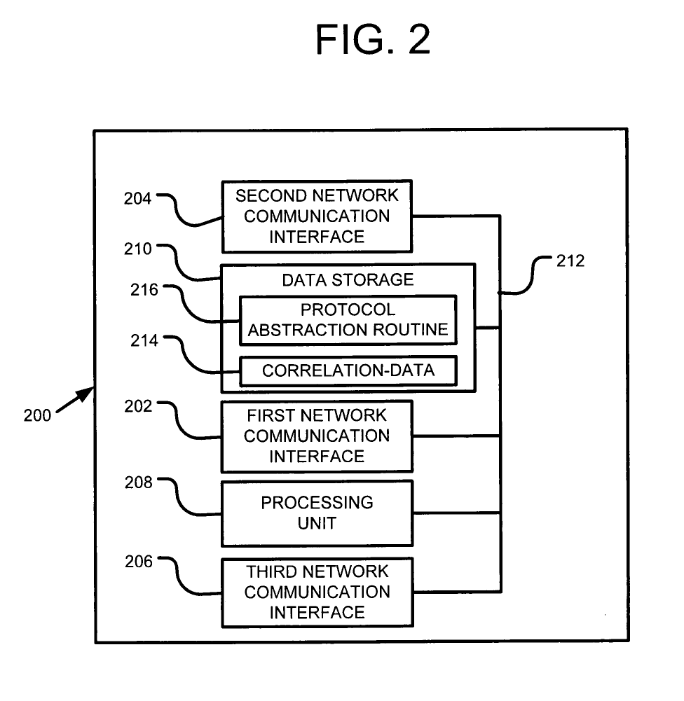

Referring to FIG. 2, a block diagram of a PDSN 200 in accordance with an exemplary embodiment is shown. The PDSN 200 shown in FIG. 2 is capable of supporting simultaneous data sessions using different RP protocols. As illustrated, the PDSN 200 may include a first network communication interface 202 for coupling the PDSN 200 to a radio access network 100, a second network communication interface 204 for coupling the PDSN 200 to a packet network 102, a third network communication interface 206 for coupling the PDSN 200 to an access, authorization, and accounting (“AAA”) server, a processing unit 208, and data storage 210, all coupled to at least one bus, illustrated as a bus 212. In an exemplary embodiment, the data storage 210 may store data, including correlation-data 214, and computer instructions, including a protocol abstraction routine 216, executable by the processing unit 208.

The stored correlation-data 214 can define a plurality of ongoing data sessions, and for each ongoing data session, a corresponding RP protocol. For instance, referring to Table 1,

TABLE 1

| IMSI Identifier | Network Address | Protocol Data Key | RP Protocol |
|---|---|---|---|
| XXXXXXXXXXXXXXA | XXX.XXX.XXX.XXX | GRE Key A | Open-RP |
| XXXXXXXXXXXXXXB | XXX.XXX.XXX.XXY | GRE Key B | Open-RP |
| XXXXXXXXXXXXXXC | XXX.XXX.XXX.XXZ | TID A, SID A | Closed-RP |

the correlation data 214 may be contained in a table having a row of information for each ongoing data session. The first column could contain an international mobile subscriber identity (“IMSI”) identifier, for instance. The IMSI identifier is a unique identifier allocated to each mobile subscriber in a GSM and UMTS network. It consists of a mobile country code (“MCC”), a mobile network code (“MNC”), and a mobile station identifier (“MSID”), and is comprised of 14 or 15 digits. Additionally, a second column could contain a network address, for instance, a third column could contain a protocol data key, and a fourth column could contain an RP protocol corresponding to the IMSI identifier, the network address, and the protocol data key, defined in the first, second, and third columns. The network address could be an Internet protocol (“IP”) address, for example. Other types of network address identifiers could also be used. IP is described in more detail in ETF RFC 791, which is incorporated herein by reference in its entirety. The protocol data key could be, for instance, a generic routing encapsulation (“GRE”) key for sessions using the open-RP transfer protocol, and a combination of a tunnel identifier (“TID”) and a session identifier (“SID”) for sessions using the closed-RP transfer protocol. Other types of protocol data keys could also be used. GRE is described is described in more detail in IETF RFCs 1701, 1702, and 2784, and TID and SID are described in more detail in IETF RFC 2661, all of which are incorporated herein by reference in their entireties. Other columns containing additional information are possible as well.

Turning back to FIG. 2, the protocol abstraction routine 216 may contain instructions for creating and updating the correlation-data 214, for identifying if a data packet corresponds to a first RP protocol (i.e., open-RP) or a second RP protocol (i.e., closed-RP), for decapsulating the data packet according to the associated RP protocol for transmission to a packet network 102 via the second network communication interface 204, and for encapsulating the data packet according to the associated RP protocol for transmission to a radio access network 100 via the first network communication interface 202. Additionally, the protocol abstraction routine 216 could contain instructions for allocating resources for managing data sessions using different RP protocols.

The protocol abstraction routine 216 could create each row of the table of correlation-data 214 during signaling when the corresponding data session is being established. The signaling data packets would provide the information required to create the rows of the table stored in the correlation-data 214. Additionally, whenever one of the values stored in the correlation-data 214 changes, the BSC could send a signaling packet to the PDSN via the PCF, and the protocol abstraction routine 216 could use the signaling packet to update the table as needed.

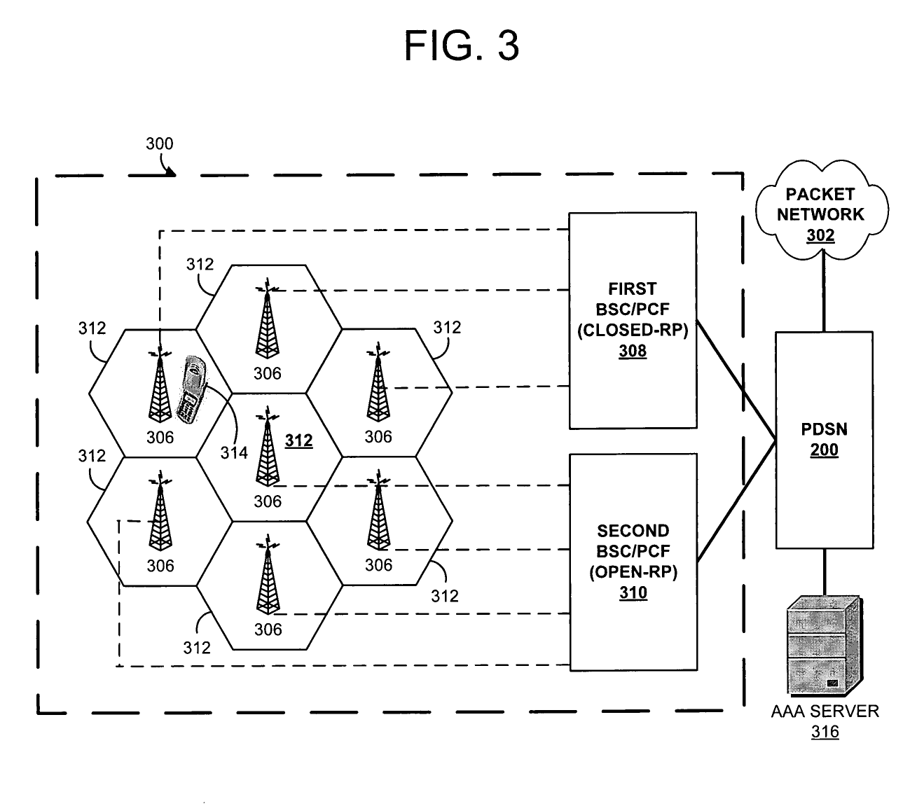

FIG. 3 is a block diagram illustrating components of a cellular radio access network 300, connected to a packet network 302 via the PDSN 200 of FIG. 2, in accordance with an exemplary embodiment. The radio access network 300 shown in FIG. 3 is the radio access 100 network shown in FIG. 1, except that where in FIG. 1 the first and second BSCs 108, 110 both used the same RP protocol, in FIG. 3, the first BSC 308 uses a closed-RP protocol to transmit to and/or receive data packets, via its PCF, from the PDSN 200 and the second BSC 310 uses an open-RP protocol to transmit to and/or receive data packets, via its PCF, from the PDSN 200. In the past, such an arrangement was not possible, and required two PDSNs 104, one for supporting closed-RP data sessions, and another for supporting open-RP data sessions. However, because the capabilities that the correlation data 214 and the protocol abstraction routine 216 stored in the data storage 210 in the PDSN 200 provide, the PDSN 200 shown in FIG. 3 is capable of supporting simultaneous data sessions using different RP protocols.

Additionally, PDSN 200 shown in FIG. 3 can be coupled to a AAA server 316, and provide a common interface to the AAA server for closed-RP and open-RP data sessions, via the PDSN's 200 third network communication interface 206. The AAA server 316 can be, for instance, a Remote Authentication Dial-In User Service (“RADIUS”) server. As is known in the art, RADIUS enables remote access servers to authenticate users and to authenticate their access to the requested system or service. The PDSN 200 may employ the AAA server 316, via the third network communication interface 206, to perform authentication during PPP sessions with mobile stations 214. The PDSN 200 may also interact with the AAA server 316 during an IP registration process.

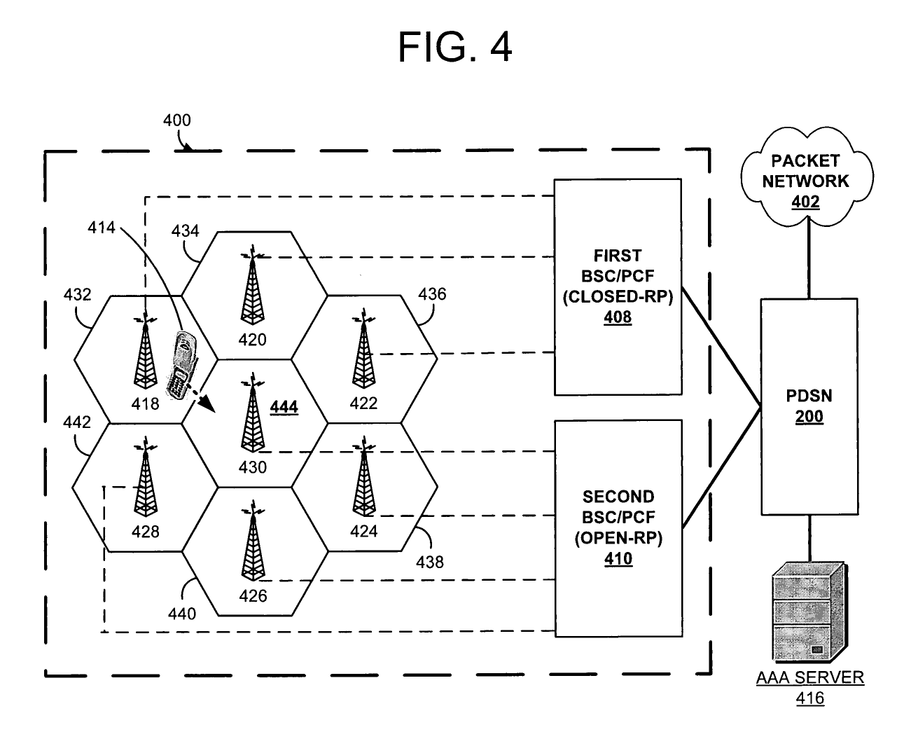

FIG. 4 is a block diagram illustrating components of a cellular radio access network 100, connected to a packet network 102 via the PDSN 200 of FIG. 2, in accordance with an exemplary embodiment. As previously described, a user located in a cell 432 might establish a data session via the BTS 418 located in that cell 432 and the BSC 408 serving the BTS 418. As a result, the connection would be established using the RP protocol of the BSC 408 that serves the BTS 418 with which the mobile station 414 is wirelessly connected. By way of example, because the mobile station 414 shown in FIG. 4 is located in a cell 432 having a BTS 418 that is coupled to the first BSC 408 that uses a closed-RP transfer protocol, a data session established by the mobile station 414 in this location would, at least initially, use the closed-RP protocol to transmit/receive data packets between the first BSC 408 and the PDSN 200.

During the course of the data session, if the mobile station 418 were to move to other cells 420, 422 served by the same BSC 408 (the first BSC), or another BSC that uses the closed-RP protocol, and is coupled to the same PDSN 200, the data session would continue to use the closed-RP protocol and, through normal cellular roaming handoff procedures, the data session might continue uninterrupted. If, however, during the data session the mobile station 418 were to move to a cell that is served by BTSs 424, 426, 428, 430 coupled to a BSC 410 that uses the open-RP and is coupled to the same PDSN 200, in addition to the normal cellular roaming handoff procedures, the information in the correlation data 214 for that session would need to be updated to reflect the fact that open-RP is now being used for the data session. The protocol abstraction routine 216 could contain instructions for making such an update in response to the PDSN 200 receiving a signaling packet containing information regarding such a change.

The protocol abstraction routine 216 could also contain instructions for using the IMSI identifier for correlating sessions during roaming handoffs between open-RP and closed-RP radio access networks 400. This correlation data 214 update, in combination with the cellular roaming handoff procedures, could allow the data session to continue uninterrupted, even when switching RP protocols. However, if the mobile station were to move to a cell served by a different PDSN than the PDSN 200 used to establish the data session, the data session would have to be reestablished as the new PDSN would have none of the information stored in the correlation data 214 regarding the data session.

2. Exemplary Operation

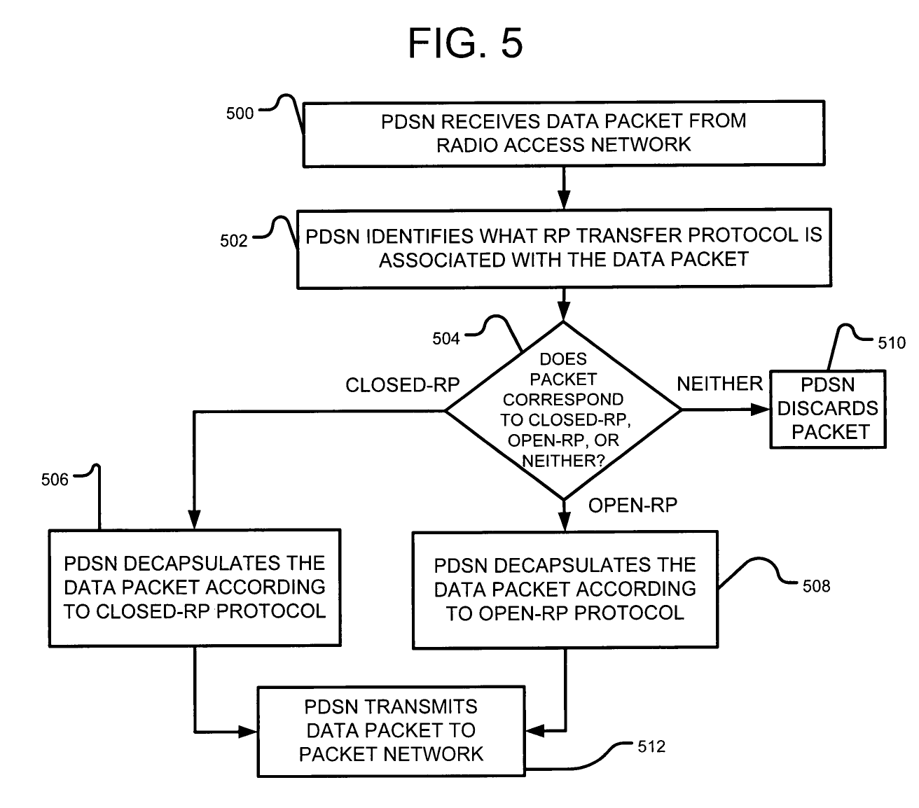

FIG. 5 is a flow chart that illustrates exemplary functions performed by the PDSN 200 in accordance with an exemplary embodiment. At step 500, the PDSN 200 receives a data packet from a radio access network 400. The PDSN receives the data packet via the first network communication interface 202 from a PCF of a BSC 408, 410 in the radio access network 400. Because the PCF encapsulates the data packet using an RP protocol (i.e., closed-RP or open-RP) prior to transmitting the data packet to the PDSN 404, the data packet received by the PDSN 200, at step 500, is an encapsulated data packet that the PCF has encapsulated according to the RP protocol.

After the PDSN 404 receives the data packet from the radio access network, the processing unit 208 executes the protocol abstraction routine 216 at step 502 to identify what RP transfer protocol is associated with the data packet. The protocol abstraction routine 216 can do this, for example, by determining what protocol data key is associated with the data packet and searching the protocol data keys stored in the correlation data 214 to determine what data session the protocol data key corresponds to and what RP protocol corresponds to the data session. The protocol abstraction routine 216 can identify what protocol data key is associated with a data packet by parsing through the data packet's header for the protocol data key. If the protocol abstraction routine 216 determines that the data packet corresponds to a closed-RP protocol at step 504, the protocol abstraction routine 216 decapsulates the data packet according to the closed-RP protocol at step 506. Alternatively, if the protocol abstraction routine 216 determines that the data packet corresponds to the open-RP protocol, at step 506, the protocol abstraction routine 216 decapsulates the data packet, at step 508, according to the open-RP protocol. If, however, the protocol abstraction routine 216 cannot determine what RP protocol the data packet corresponds to, the protocol abstraction routine 216 will discard the data packet at step 510.

After the data packet has been decapsulated according to its corresponding RP protocol, the PDSN 200 transmits the decapsulated data packet to a packet network 402 via the second network communication interface 204, at step 512.

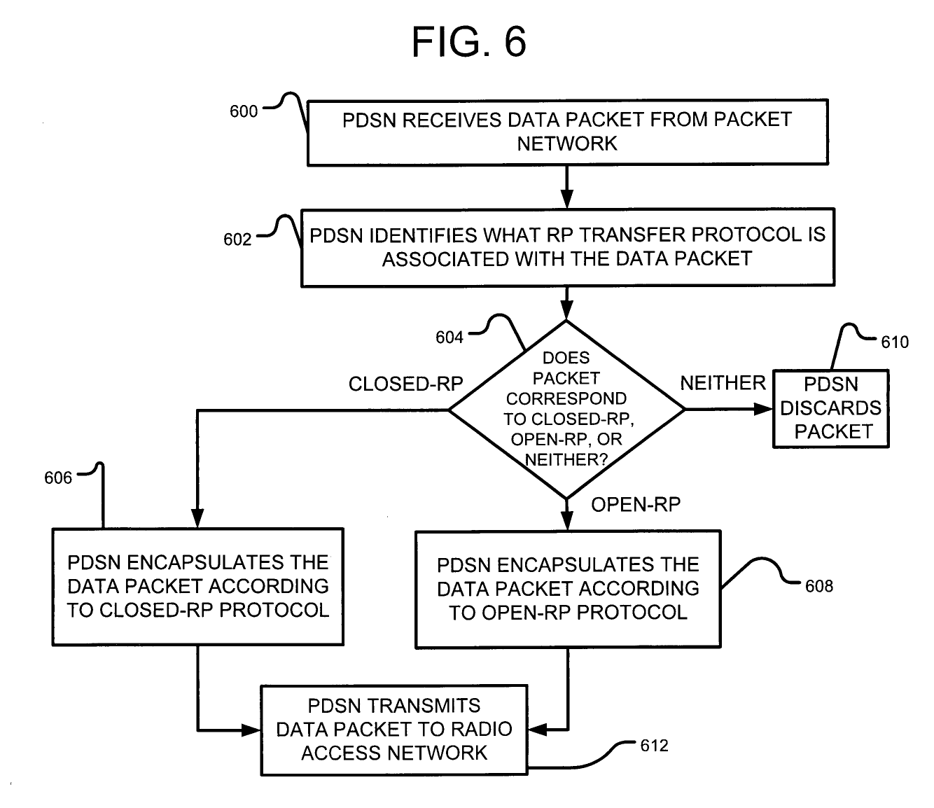

FIG. 6 is a flow chart that illustrates exemplary functions performed by the PDSN 404 in accordance with an exemplary embodiment. At step 600, the PDSN 200 receives a data packet, via the second network communication interface 204, from a packet network 402, such as the Internet. In order for the PDSN 200 to transmit the data packet to the radio access network 400, it must encapsulate the data packet using the RP protocol corresponding to that data session and data packet (i.e., closed-RP or open-RP). Therefore, after the PDSN 200 receives the data packet from the packet network 402, the processing unit 208 executes the protocol abstraction routine 216 at step 602 to identify what RP transfer protocol is associated with the data packet. The protocol abstraction routine 216 can do this by, for example, determining what network address (i.e., IP address) is associated with the data packet, and searching the network addresses stored in the correlation data 214 to determine what data session the IP address is associated with, and what RP protocol corresponds to the associated data session.

The protocol abstraction routine 216 can determine what network address is associated with the data packet by simply reading the header of the received data packet. If the protocol abstraction routine 216 determines, at step 604, that the data packet corresponds to a closed-RP protocol, the protocol abstraction routine 216 encapsulates the data packet according to the closed-RP protocol at step 606. Alternatively, if the protocol abstraction routine 216 determines, at step 606, that data packet corresponds the open-RP protocol, the protocol abstraction routine 216 encapsulates the data packet according to the open-RP protocol at step 608. If, however, the protocol abstraction routine 216 cannot determine what RP protocol the data packet corresponds to, the protocol abstraction routine 216 will discard the data packet at step 610.

After the protocol abstraction routine 216 has encapsulated the data packet according to its corresponding RP protocol, the PDSN 200 transmits the data packet, at step 612, to the radio access network 400 via the first network communication interface 202 for delivery to the corresponding mobile station 414.

3. Conclusion

In the past, PDSNs have only been able to support simultaneous data sessions using a single RP protocol, requiring at least one PDSN for each RP protocol in use on a network. The PDSN 200 of the exemplary embodiment, however, provides the capability to support simultaneous data sessions using multiple RP protocols. This capability allows network service providers to simplify their network infrastructure, lower maintenance costs, and reduce their investment costs by using a single PDSN 200 to support data sessions using multiple RP protocols. Additionally, this PDSN 200 provides the ability for a user to seamlessly roam from one cellular sector having radio access network equipment using a first RP protocol (i.e., open-RP) to another sector having radio access network equipment using a second RP protocol (i.e., closed-RP). Where in the past such roaming would have required the network to switch the data session to another PDSN, thereby possibly requiring that the data session be reestablished, the exemplary embodiment enables the data session to continue using the same PDSN 200.

An exemplary embodiment has been described above. Those skilled in the art will understand, however, that changes and modifications may be made to this embodiment without departing from the true scope and spirit of the invention, which is defined by the claims.

1. A Packet Data Serving Node (“PDSN”) comprising:
a first network communication interface for connection to a first network;
a second network communication interface for connection to a second network; and
a protocol abstraction routine executable by a processing unit to identify if a data packet is associated with at least one of a first RP transfer protocol or a second RP transfer protocol, and to at least one of decapsulate or encapsulate the data packet according to the associated RP transfer protocol for transmission to one of the first network or the second network.

2. The PDSN of claim 1 wherein the first RP transfer protocol is open-RP and the second RP transfer protocol is closed-RP.

3. The PDSN of claim 1 wherein the first network is a radio access network and the second network is a packet network.

4. The PDSN of claim 3 wherein the packet network is the Internet.

5. The PDSN of claim 3 wherein if the data packet is for transmission to the radio access network, the protocol abstraction routine encapsulates the data packet for transmission, and if the data packet is for transmission to the packet network, the protocol abstraction routine decapsulates the data packet for transmission.

6. The PDSN of claim 1 further comprising correlation-data stored in data storage, the correlation data defining parameters associated with an ongoing data session, wherein the parameters correspond to at least one of the first RP transfer protocol or the second RP transfer protocol.

7. The PDSN of claim 1 wherein the protocol abstraction routine is further arranged to simultaneously support a first data session using the first RP transfer protocol and a second data session using the second-RP protocol.

8. A PDSN comprising:
a first network communication interface for connection to a radio access network;
a second network communication interface for connection to a packet network;
a processing unit;
data storage;
correlation-data stored in the data storage, the correlation-data defining parameters associated with an ongoing data session, wherein the parameters correspond to at least one of a first RP transfer protocol or a second RP transfer protocol; and
a protocol abstraction routine stored in the data storage and executable by the processing unit to identify if a data packet received from a radio access network is associated with at least one of the first RP transfer protocol or the second RP transfer protocol, and to decapsulate the data packet according to the associated RP transfer protocol for transmission of the data packet between the radio access network and a packet network.

9. The PDSN of claim 8 wherein the protocol abstraction routine is further arranged to identify if a further data packet received from the packet network is associated with at least one of the first RP transfer protocol or the second RP transfer protocol, and to encapsulate the further data packet according to the associated RP transfer protocol for transmission of the further data packet between the packet network and the radio access network.

10. The PDSN of claim 9 wherein the first RP transfer protocol is open-RP and the second RP transfer protocol is closed-RP.

11. The PDSN of claim 9 wherein the protocol abstraction routine is further arranged to simultaneously support a first data session using the first RP transfer protocol and a second data session using the second-RP transfer protocol.

12. A PDSN comprising:
a first network communication interface for connection to a radio access network;
a second network communication interface for connection to a packet network;
a processing unit;
data storage;
correlation-data stored in the data storage, the correlation-data defining parameters associated with an ongoing data session, wherein the parameters correspond to at least one of a first RP transfer protocol or a second RP transfer protocol; and
a protocol abstraction routine stored in the data storage and executable by the processing unit to identify if a data packet received from a packet network is associated with at least one of the first RP transfer protocol or the second RP transfer protocol, and to encapsulate the data packet according to the associated RP transfer protocol for transmission of the data packet between the packet network and a radio access network;

13. The PDSN of claim 12 wherein the first RP transfer protocol is open-RP and the second RP transfer protocol is closed-RP.

14. The PDSN of claim 12 wherein the protocol abstraction routine is further arranged to simultaneously support a first data session using the first RP transfer protocol and a second data session using the second-RP transfer protocol.

15. A method for supporting simultaneous data sessions on dissimilar access networks, the method comprising:
receiving a data packet from a first network;
identifying if the data packet corresponds to at least one of a first RP transfer protocol or a second RP transfer protocol;
at least one of encapsulating or decapsulating the data packet according to the first RP transfer protocol when the data packet is associated with the first RP transfer protocol;
at least one of encapsulating or decapsulating the data packet according to the second RP transfer protocol when the data packet is associated with the second RP transfer protocol; and
transmitting the data packet to a second network.

16. The method of claim 15 wherein the first RP transfer protocol is open-RP and the second RP transfer protocol is closed-RP.

17. The method of claim 15 wherein when the first network is a radio access network and the second network is a packet network the data packet is decapsulated.

18. The method of claim 15 wherein when the first network is a packet network and the second network is a radio access network the data packet is encapsulated.

19. A method for supporting simultaneous data sessions on dissimilar access networks, the method comprising:
receiving a data packet from at least one of a radio access network or a packet network;
identifying if the data packet corresponds to at least one of a first RP transfer protocol or a second RP transfer protocol using a protocol abstraction routine;
decapsulating the data packet, using the protocol abstraction routine, according to the first RP transfer protocol when the data packet is received from a radio access network and is associated with the first RP transfer protocol, for transmission to a packet network;
decapsulating the data packet, using the protocol abstraction routine, according to the second RP transfer protocol when the data packet is received from the radio access network and is associated with the second RP transfer protocol, for transmission to the packet network;
encapsulating the data packet, using the protocol abstraction routine, according to the first RP transfer protocol when the data packet is received from the packet network and is associated with the first RP transfer protocol, for transmission to the radio access network;
encapsulating the data packet, using the protocol abstraction routine, according to the second RP transfer protocol when the data packet is received from the packet network and is associated with the second RP transfer protocol, for transmission to the radio access network; and
transmitting at least one of a decapsulated data packet to the packet network or an encapsulated data packet to the radio access network.

20. The method of claim 19 wherein the first RP transfer protocol is open-RP and the second RP transfer protocol is closed-RP.
